(19) United States
(12) Patent Application Publication
(10) Pub. No.: US 2020/0004524 A1
(43) Pub. Date: Jan. 2, 2020

(54) METHOD AND APPARATUS FOR CONFIRMING STATUS OF A REMOTE UPDATE

(71) Applicant: FORD GLOBAL TECHNOLOGIES, LLC, Dearborn, MI (US)

(72) Inventors: Ali Mohamad SULEIMAN, Dearborn, MI (US); Balwinder Kaur GILL, Canton, MI (US); Mohamad NASSER, Dearborn Heights, MI (US); Vijayababu JAYARAMAN, Novi, MI (US); Karl Nathan CLARK, Belleville, MI (US)

(21) Appl. No.: 16/025,580

(22) Filed: Jul. 2, 2018

(51) Int. Cl. G06F 8/65; H04L 29/08

(52) U.S. Cl. CPC G06F 8/65; H04W 84/12; H04L 67/34

(57) ABSTRACT

A system includes a processor configured to add to a queue a status message relating to a vehicle software update. The processor is also configured to determine that a device, including long-range connectivity, is connected to a vehicle computer. The processor is further configured to upload the queue to the device, responsive to the determination and instruct the device to deliver the queue to an identified remote server

### TECHNICAL FIELD

The illustrative embodiments generally relate to methods and apparatuses for confirming status of a remote update.

### BACKGROUND

While new vehicles may often have telematics capability, via an onboard phone or modem, or may have the capability to interact with a mobile device to temporarily obtain remote communication capability, many other systems may lack any formal method of remote communication.

In these older vehicles, software update handling is usually either done by a dealer/mechanic, or by a customer using a portable memory device, such as a USB stick. After the update is downloaded to the memory device, for example, the customer can insert the device into a vehicle port and the vehicle can process the update. While this is a viable method of updating software on the vehicle, a remote system then has no knowledge of whether the update was installed. When a user requests a future update, the remote software does not know if the previous update was installed.

### SUMMARY

In a first illustrative embodiment, a system includes a processor configured to queue a status message relating to a vehicle software update. The processor is also configured to determine that a device, including long-range connectivity, is connected to a vehicle computer. The processor is further configured to upload the queue to the device, responsive to the determination and instruct the device to deliver the queue to an identified remote server.

In a second illustrative embodiment, a system includes a processor configured to receive a queue from a connected vehicle computing system. The processor is also configured to receive a remote server address from the vehicle computing system. The processor is further configured to determine that a device is connected to a wide-range network, capable of achieving data transfer with the identified remote server address. The processor is also configured to deliver the queue to a remote server at the address, responsive to the determination.

In a third illustrative embodiment, a system includes a processor configured to receive a status queue from a mobile device, delivered on behalf of a vehicle computing system to which the status queue applies. The processor is also configured to log queue contents with regards to a vehicle software status record for a specific vehicle including the vehicle computing system. The processor is further configured to determine a predefined remote follow-up action based on a status indicated by the queue contents and communicate with a remote source to complete the determined remote follow-up action.

### BRIEF DESCRIPTION OF THE DRAWINGS

FIG. 1 shows an illustrative vehicle computing system;

FIG. 2 shows an illustrative example of an installation and report queuing process;

FIG. 3 shows an illustrative example of a queue transport process;

FIG. 4 shows an illustrative example of a data relay process; and

FIG. 5 shows an illustrative example of a queue data reception process.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

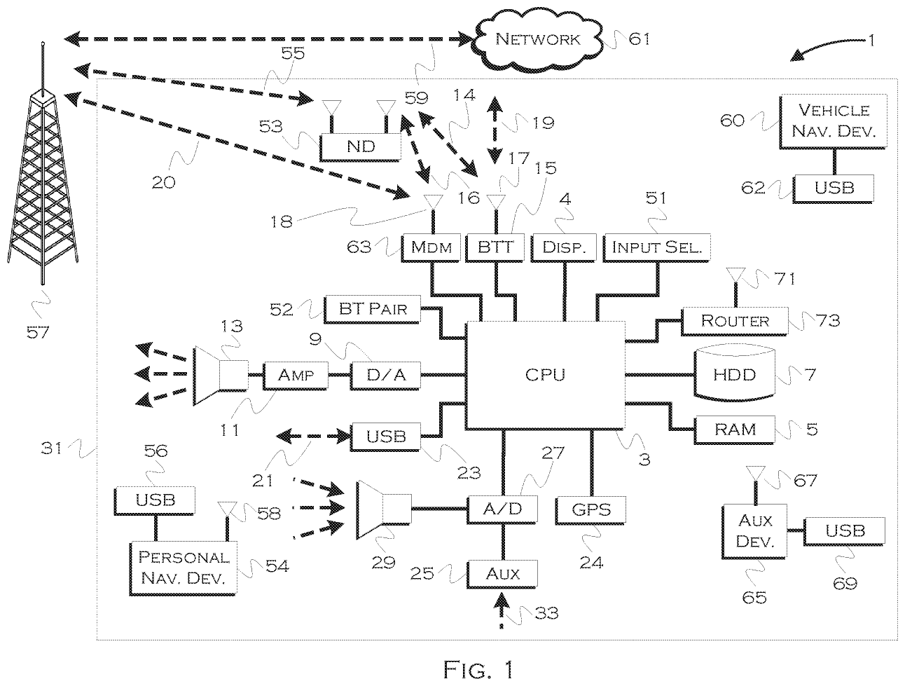

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

By providing alternative communication transport options for vehicles lacking telematics or wide range communication capability, the illustrative concepts and embodiments provide opportunities to improve the utility and functionality of software update systems by helping ensure that remote software update servers know current vehicle installation statuses. The novel, uncommon and atypical examples and concepts described herein demonstrate potential improvements achievable through use of those examples, concepts, and the like.

Software updates for large vehicle fleets may be managed by centralized server processes. These servers may keep track of various module versions installed on deployed vehicles, and the systems may thus responsively provide a current and appropriate update, upon request, for a given vehicle module.

While vehicles equipped with telematics systems or other long range remote communication capability, capable of communicating with remote update management servers, may process updates in an over-the-air manner, vehicles lacking such capabilities may rely on human intervention to process an update.

In the systems lacking communication, a user might download an update to a portable memory device, such as a USB stick, and use the memory device to install the update directly into a vehicle, by plugging the device into a USB port provided to the vehicle. The user may need to take further action, onboard the vehicle, to install the update, or the update may process automatically. If the update succeeds, fails or otherwise has a status associated therewith, the remote server may remain unaware of this change. Thus, if the user were to request another update, the user may have to first identify a current installed version for the remote server, else the server would have to “guess” at the update or provide a series of updates working from a last-known valid configuration.

The illustrative embodiments improve the communication of information to the server by leveraging temporary connectivity solutions to report back update and version statuses. Even if a vehicle lacks onboard long-range communication, it may still be able to communicate locally with a mobile device (e.g., cell phone) that has wide/long range communication. By communicating with such a device, the vehicle can instruct the device to act as a relay for the updated information, thus using the device as a courier for relaying status updates to the server. This can be done without direct interaction by the user if desired, removing the potential for forgetfulness on the part of the user to negatively impact the user experience.

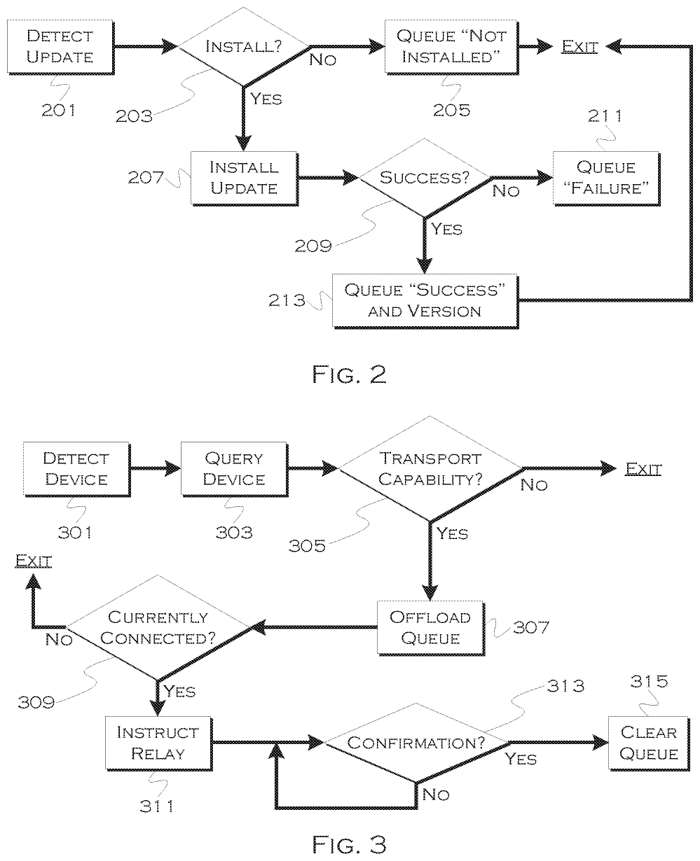

FIG. 2 shows an illustrative example of an installation and report queuing process. In this example, the process detects 201 that an update has been uploaded to the vehicle computer, or is otherwise present and available for installation (e.g., exists on a memory stick). If the update is present but not installed 203, the process can queue 205 a “not installed” message as a message to be relayed to a server. A later “installed,” “error,” or other message with a more recent timestamp can overwrite or supersede this message, if the status has so changed.

If the user elects to proceed with installation (or if installation is automatic), the process can attempt 207 to install the update. Because such attempts may fail for a variety of reasons, the process can determine 209 whether or not the installation was successful. If the installation was a success, the process can queue 213 a “success” message for the remote server, which may also include a current version number and any other pertinent information. If the installation fails, the process can queue 211 a “failure” message for later transmission to the server. In this manner, various status messages can be prepared for eventual transmission to the server, reflecting the update status and the current module versions (as well as other relevant information, as needed).

FIG. 3 shows an illustrative example of a queue transport process. In this example, the process may detect 301 that a mobile device (e.g., a phone) has been wiredly or wirelessly connected to the vehicle. Because not all such devices include wide range communication capability, the process may further attempt to determine if the device includes the requisite capability by querying 303 the device. In some instances, the process may further query for information relating to, for example, an application necessary to transmit the information to the remote server, if such a model is employed.

If the device includes 305 the desired capability (communication, application, etc), the process may offload 307 a queue of status messages to the device. These may reflect any current messages, messages since a last offload, messages for which receipt has not been confirmed, etc.

Also, in this example, if the device is currently connected (e.g., a phone having a network signal) 309, the process may instruct 311 the device (or application on the device) to send the message to the server immediately (if possible). This allows the process to receive immediate confirmation 313 once the upload is complete, and thus the process can delete 315 the queue.

If the device lacks immediate communication capability (i.e., is not currently connected or is otherwise engaged), the process can instruct the device to queue the transport, or an application on the device to do the same. Then, when the device later becomes connected, the device can send the relevant queue data to the remote server, receive a confirmation if desired, and later relay the confirmation to the vehicle.

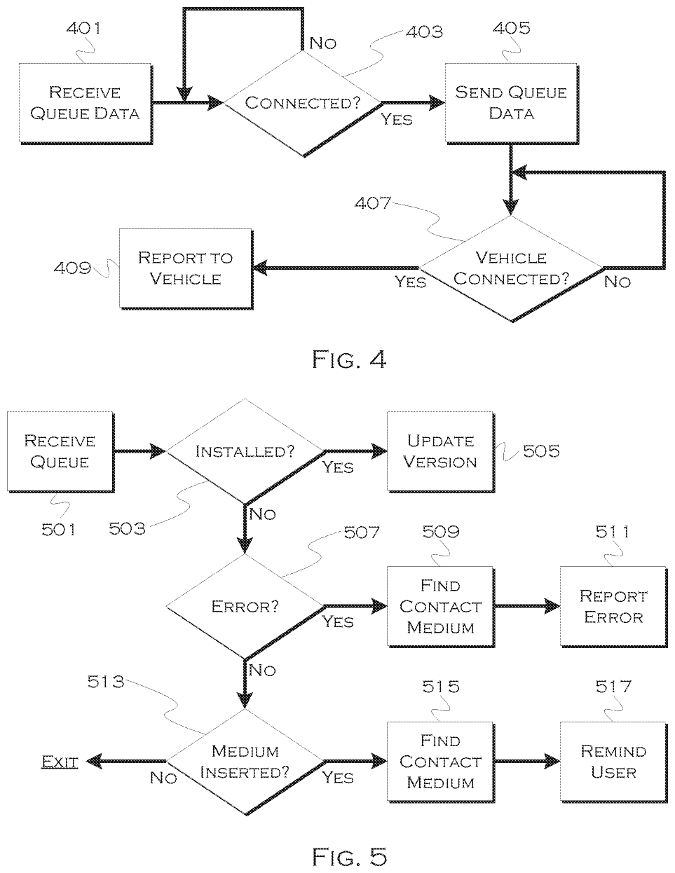

FIG. 4 shows an illustrative example of a data relay process. In this example, the process may be executing on a device with wide range communication capability, such as a mobile phone, smart watch, tablet, etc. In this example, the process receives 401 queue data from the vehicle, once the mobile device is connected to the vehicle. The mobile device can use Wi-Fi, cellular or other suitable communication capable of long-range relay, in order to convey the message to the remote server. While Wi-Fi itself is not traditionally wide range, it can be used to connect to a broader network, such as the internet, and in some instances may be suitable for sending the queue data.

In this example, the process waits until the device is connected to a network having eventual access to the server 403, and then sends 405 the queue data received from the vehicle. The process may execute as part of native phone software, if such capabilities working in conjunction with a vehicle are made native to the phone, or the process may execute as part of an original equipment manufacturer (OEM) application executing on the phone.

The process may also receive a response from the remote server, confirming the queue has been received, or the process may simply log the fact of having sent the queue data, if there are reasonable assurances that the message will be delivered when sent. In this example, once the device is reconnected to the vehicle 407, the device can report 409 to the vehicle that the queue data was successfully relayed. This can act as a trigger for causing the vehicle to delete the now-delivered queue.

FIG. 5 shows an illustrative example of a queue data reception process. In this example, the process may execute on the remote server, for example. Here, the process receives 501 a queue message from the mobile device acting as a courier for the message. The process determines if the message indicates that the software was successfully installed 503, and if so, the process updates 505 the version number and any other relevant information.

If the queue indicates that there was an error 507 installing the software, the process may attempt to find 509 a suitable contact medium (text, call, email, etc) for the user. This may be useful because the user may have no idea of the error state, and may assume the update has been installed. Once the process finds the contact medium, the process can send 511 a message to the user informing the user of the error and any mitigating steps to take to install the software correctly.

If there is no error, the process may determine if the queue message indicates that the storage medium (holding the update) was even inserted 513. If the medium was never inserted, the process may assume that there was no attempt yet to install the software, and may exit. If the medium was inserted, but further user action was required to install the software, the user may not be aware of this. Again, the process determines 515 a contact medium preferred by the user and reminds or informs the user to take the follow-on action in order to complete the installation.

Since the vehicle itself may lack remote communication capability, it may not be the best medium for informing the user of errors or issues. The vehicle can presumably only easily contact the user through a vehicle display, which may not even exist. By having the remote server communication with the user through a secondary medium (other than the vehicle), the process can somewhat ensure that an appropriate message was delivered to the user. The vehicle can determine and track various states (installed, error, inserted, etc), and then the remote server can act on these states once the queue has been relayed through the mobile device.

The illustrative embodiments allow for a wide-range connected device to act as a courier for a vehicle update message between the unconnected (in a wide range sense) vehicle and a software update server. This improves the ability of such vehicles to report update statuses, and improves the reliability and efficiency of the system, as well as minimizing the impact to and actions required of the user.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1. A system comprising:
a processor configured to;
add to a queue a status message relating to a vehicle software update;
determine that a device, including long-range connectivity, is connected to a vehicle computer;
upload the queue to the device, responsive to the determination; and
instruct the device to deliver the queue to an identified remote server.

2. The system of claim 1, wherein the status message includes a successful installation message.

3. The system of claim 1, wherein the status message includes an error in installation message.

4. The system of claim 1, wherein the status message includes a message indicating that user action is required.

5. The system of claim 1, wherein the processor is configured to determine that the device includes long-range connectivity based on querying the device.

6. The system of claim 5, wherein the querying includes querying the device for connectivity options.

7. The system of claim 6, wherein the processor is configured to instruct the device to deliver the queue using a native device-function.

8. The system of claim 5, wherein the querying includes querying the device for the existence of a queue-delivery capable application.

9. The system of claim 8, wherein the processor is configured to instruct the device to deliver the queue by instructing the application to deliver the queue.

10. A system comprising:
a processor configured to:
receive a queue from a connected vehicle computing system;
receive a remote server address from the vehicle computing system;
determine that a device is connected, at a point in time following receipt of the queue, the queue having been received at a time when the device was not connected, to a wide-range network capable of achieving data transfer with the identified remote server address; and
responsive to the determination, deliver the queue to a remote server at the address.

11. The system of claim 10, wherein the processor is further configured to deliver the queue responsive to a delivery instruction received from the vehicle computing system.

12. The system of claim 10, wherein the processor is further configured to receive a response from the remote server and deliver the response to the vehicle computing, system.

13. The system of claim 10, wherein the processor is further configured to determine that the vehicle computing system is connected following queue delivery and to deliver a confirmation responsive to determining that the vehicle computing system is connected.

14. The system of claim 10, wherein the wide-range network includes a cellular network.

15. The system of claim 10, wherein the wide-range network includes a Wi-Fi network connected to the Internet.

16. A system comprising:
a processor configured to:
receive a status queue from a mobile device, delivered on behalf of a vehicle computing system to which the status queue applies;
log queue contents with regards to a vehicle software status record for a specific vehicle including the vehicle computing system;
determine a predefined remote follow-up action based on a status indicated by the queue contents; and
communicate with a remote source to complete the determined remote follow-up action.

17. The system of claim 16, wherein the status includes a successful installation and the predefined remote follow-up action includes sending a message to a user indicating successful installation.

18. The system of claim 16, wherein the status includes an error in installation and the predefined remote follow-up action includes notifying the user that the installation should be reattempted.

19. The system of claim 16, wherein the processor is further configured to determine a preferred communication medium, associated with the vehicle and predefined for contacting a vehicle owner, and communicate with the remote source via the communication medium.

20. The system of claim 16, wherein the status includes an indication that a medium including a software update was interfaced with the vehicle computing system, but that user action is required to complete the installation, and wherein the predefined remote follow-up action includes notifying the user that the user action is required.
